(19) United States
(12) Patent Application Publication
(10) Pub. No.: US 2004/0030890 A1
(43) Pub. Date: Feb. 12, 2004

(54) Method for back tracing authentication status in a hierarchical intermedia architecture

(75) Inventors: Pei-Hua Chu, Hsinchu (TW); Yung-Hsin Chen, Hsinchu (TW)

Correspondence Address: BACON & THOMAS, PLLC, 625 SLATERS LANE, FOURTH FLOOR, ALEXANDRIA, VA, 22314

(73) Assignee: D-Link Corporation, Hsinchu (TW)

(21) Appl. No.: 10/214,174

(22) Filed: Aug. 8, 2002

(51) Int. Cl. H04L 9/00; G06F 11/30

(52) U.S. Cl. 713/161; 713/201

(57) ABSTRACT

The invention relates to a method for back tracing an authentication status implemented in a hierarchical intermedia architecture, where a RADIUS server is sequentially connected to at least one intermedium by means of a hierarchical connection, each intermedium is connected to at least one end point respectively, the hierarchical intermedia architecture utilizes a hierarchical back trace protocol packet, so that when each end point finds that it does not pass an authentication the end point can issue the protocol packet for requesting the intermedia to back trace nodes in the hierarchical intermedia architecture sequentially and commanding the intermedia to send information back to the end point for identifying the status and errors of the intermedia.

### FIELD OF THE INVENTION

The present invention relates to network and more particularly to a method for back tracing an authentication status in a hierarchical intermedia architecture with improved characteristics.

### BACKGROUND OF THE INVENTION

Over the past decade there has been a considerable growth in network technology. Also, a variety of network devices have been developed and widely employed in our daily life and almost all trades. Such trend of expansion not only increases speed and efficiency of information communication but also brings a great convenience to our life and work. Recently, more information is communicated over the network by implementing a wireless LAN (Local Area Network) technology as the number of installed wireless LAN interface cards increases gradually. However, it is very possible that a hacker may invade the wireless LANs because there is no protection implemented on many wireless LANs. A typical technique employed by a hacker is detailed below. The hacker simply carries a notebook computer equipped with 802.11 wireless network interface card. Next, the hacker searches a wireless LAN without protection in a public facility. In a case that any other notebook computer equipped with 802.11 wireless LAN, infrared, or bluetooth transmission equipment is being used in the public facility, it is very possible that the notebook computer is invaded by the nearby hacker. The hacker thus can use features available on the notebook computer such as broadband or Internet access, or even invade an Intranet for stealing confidential information, implanting computer viruses, or modifying Webpages in an unauthorized manner. In view of above, the wireless LAN is the weakest line of network infrastructure.

For solving the problem, there is a trend of adopting network security and authentication mechanism in the development of network-based products. As to the authentication mechanism, an IEEE 802.1x standard is typically employed. Such standard is a widely used one. It utilizes an EAPoL (Extensible Authentication Protocol Over LAN) which is used in conjunction with a RADIUS (Remote Authentication Dial-In User Service) so as to effect a very effective management mode with respect to the authentication. In a case that the IEEE 802.1x standard is employed an encryption key management mechanism is provided thereby. Hence, whenever accessing to the network a user can use an encryption key which is different from that used in a previous access. Further, the IEEE 802.1x standard supports a concentrated authentication, identification (ID), and user name management architecture such as Kerberos and RADIUS. In general, the IEEE 802.1x a new standard derived for solving a problem of insufficient security of the IEEE 802.11. It can enhance a port-based network access control. As to the problem of insufficient security of the IEEE 802.11, it comprises a lack of user ID authentication mechanism and a dynamic data encryption key assignment mechanism. By utilizing the IEEE 802.1x standard a number of advantages are obtained. For example, a RADIUS server can cooperate with a user name database. Furthermore, a business or (ISP) Internet service provider can effectively manage an access of a mobile user to the wireless LAN. In addition, before the user gains permission to access to a wireless LAN administered by the IEEE 802.1x standard, it is possible of providing a user name and password (or digital certificate) to a subsequent RADIUS server by means of EAPoL via a wireless retrieving device or network broadband router. The user can access the wireless LAN only after he/her has passed an authentication through the RADIUS server. At this time, the RADIUS server begins to record a length of time from the log-on to a future exit for serving as a means of calculating charge or monitoring a current status of the network.

However, in a process of authenticating an end point it is typical that it only knows whether there is a successful connection between an upper server of the device and the end point. As to a case that the authentication is failed due to password error, user name error, or the like the connection port is blocked. It is known that in a hierarchical network architecture a route of authentication may pass a number of authentication mechanisms including intermedia and EAPoL. At this time, the end point only knows that the authentication is failed rather than being aware of which section is wrong. In other words, the end point only knows a denial authentication rather than being aware of which section failing the authentication. As such, the end point cannot back trace. This can cause a great problem for end point in locating errors or troubleshooting the system malfunctions.

Currently, for a LAN employing the IEEE 802.1x standard, an EAPoL is employed as an authentication basis between an end point and a server. If the authentication is passed the network device will unblock the connection port for permitting packet data to pass for communication over the network. If the authentication failed, the connection port will be blocked, thus disconnecting the end point from the network. In such conventional authentication mechanism only an authentication result is available rather than being aware of which section failing the authentication because the IEEE 802.1x standard does not support a hierarchical back trace mechanism. Such really causes a great bothering to network manager and/or user in locating errors in this even complicated network product environment especially in the hierarchical intermedia architecture. Thus, a considerable time and labor are spent on solving the problem.

Referring to FIG. 1, a local authentication in a hierarchical intermedia architecture is illustrated. In a case that end points S14, S15 and S16 pass an authentication on EAPoL, and an end points S13 and a network server D13 pass an authentication on EAPoL at a network server D12. But am end point S12 does not pass an authentication on EAPoL at the network server D12. Also, the network server D12 does not pass an authentication on EAPoL at a network server D11. At this time, lines L14, L15, L16, L17, and L18 are connected but lines L12 and L13 are disconnected. Hence, the end point S14 can be connected to each of the end points S15, S16, and S13 rather than to the end points S12 and S11. Also, after the end point S14 has passed the authentication it still does not know which one(s) of the end points (e.g., S12) is malfunctioned or which network is inaccessible (e.g., S11).

Referring to FIG. 2, a concentrated authentication in another hierarchical intermedia architecture is illustrated. In this hierarchical intermedia architecture an additional RADIUS server R21 is provided as a server for the concentrated authentication. As shown, an end point S21 is authenticated as a success by a RADIUS server R21 via a server D21. As to an end point S22 and a network server D22, they failed the authentication. At this time, lines L20 and L21 are connected but lines L22 and L23 are disconnected. Hence, before end points S23, S24, S25, and S26 and a network server D23 are authenticated they must connect to the server R21. As such, the end points S23, S24, S25, and S26 and the network server D23 cannot pass the authentication because the line L23 is disconnected. Likewise, the end point S24 only obtain information about authentication fail rather than being aware of which section failing the authentication.

Thus, for network device and system providers it is desirable to provide an effective back trace mechanism for user or manager easily and precisely being aware of which section failing the authentication without affecting a network security authentication mechanism.

### SUMMARY OF THE INVENTION

It is therefore an object of the present invention to provide a method for back tracing an authentication status in a hierarchical intermedia architecture wherein a hierarchical back trace protocol packet is designed in the hierarchical intermedia architecture. When an end point finds that it does not pass an authentication the end point can issue the protocol packet for requesting the intermedia to back trace nodes in the hierarchical intermedia architecture sequentially and commanding the intermedia to send back response packets each including information about authentication pass and authentication fail of all intermedia.

In one aspect of the present invention, each end point can analyze information brought back in the response packet so as to clearly and quickly back trace errors occurred on the hierarchical intermedia architecture with respect to a hierarchical intermedia architecture providing a 802.1x authentication mechanism. The errors are then corrected immediately so as to greatly reduce time spent on error detection and debugging in the authentication process and significantly increase a convenience of network concentrated authentication, management and maintenance.

In another aspect of the present invention, as to contents of the protocol packet only error messages about authentication problems are included rather than additional information about contents of the intermedia. Thus, a hacker is not capable of obtaining useful information from the back trace mechanism. As a result, an invasion into the intermedia and a potential damage thereto are prevented.

The above and other objects, features and advantages of the present invention will become apparent from the following detailed description taken with the accompanying drawings.

### BRIEF DESCRIPTION OF THE DRAWINGS

FIG. 1 presents schematically the connection of a local authentication in a conventional hierarchical intermedia architecture;

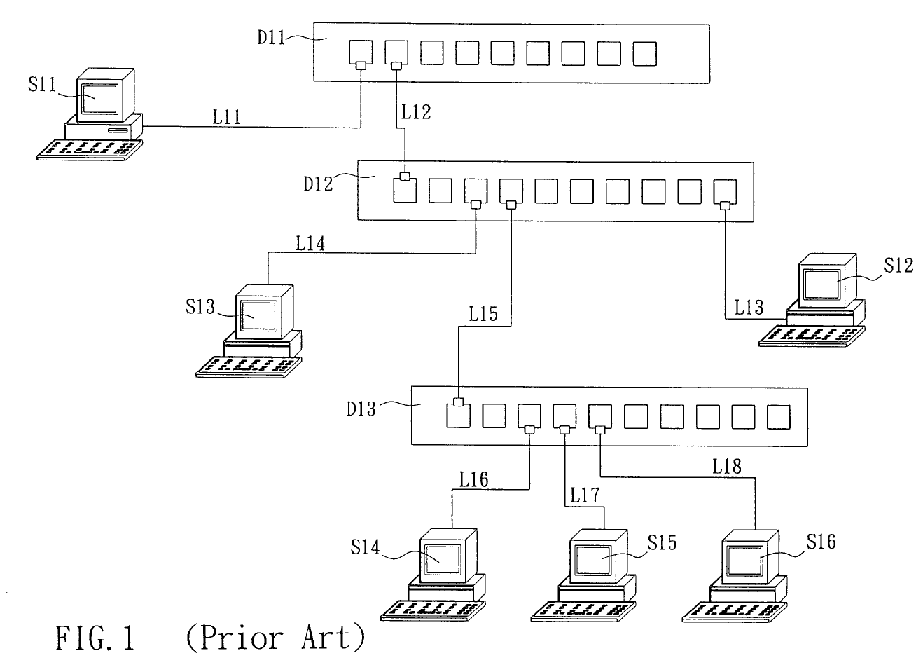

FIG. 2 presents schematically the connection of a concentrated authentication in another conventional hierarchical intermedia architecture;

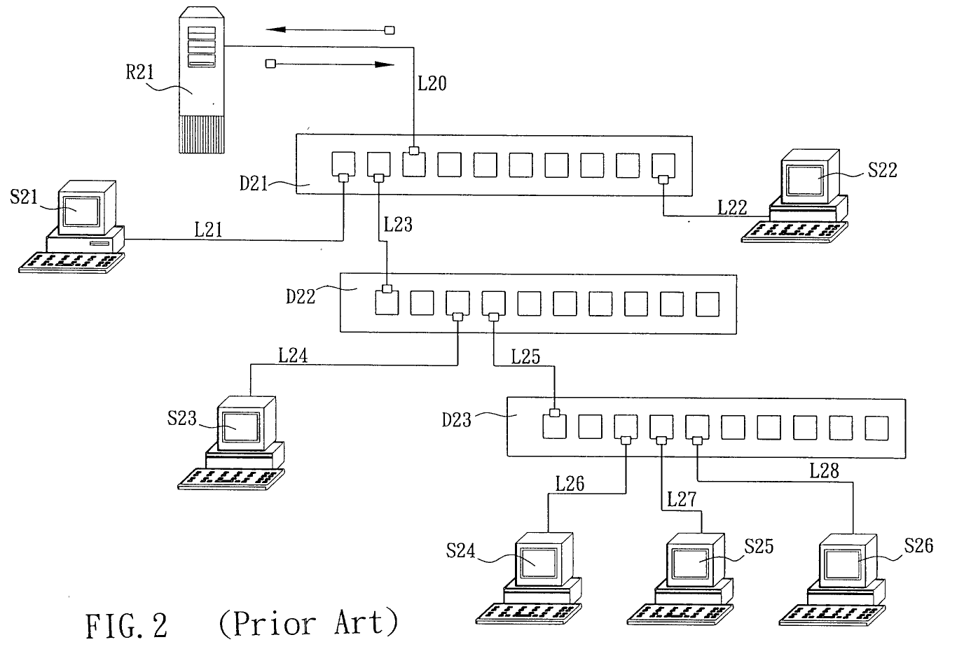

FIG. 3 presents schematically the connection of a concentrated authentication in a hierarchical intermedia architecture according to a preferred embodiment of the invention;

FIG. 4 depicts a diagram about a back traced response packet sent back from the intermedia according to the preferred embodiment; and

FIG. 5 depicts a diagram about another back traced response packet sent back from the intermedia according to the preferred embodiment.

### DETAILED DESCRIPTION OF THE PREFERRED EMBODIMENTS

The invention is directed to a devised hierarchical back traced protocol packet in the hierarchical intermedia architecture for enabling each end point to quickly know which node fails an authentication. When the end point finds that it does not pass the authentication the end point can issue the protocol packet for requesting the intermedia to back trace nodes in the hierarchical intermedia architecture sequentially and commanding the intermedia to send back response packets each including information (e.g., intermedium name, device ID, or Mac address, time and authentication fail reasons) about authentication pass and authentication fail of all intermedia. As such, the end points can find nodes that fail the authentication by analyzing information brought back in the response packet and correct the same.

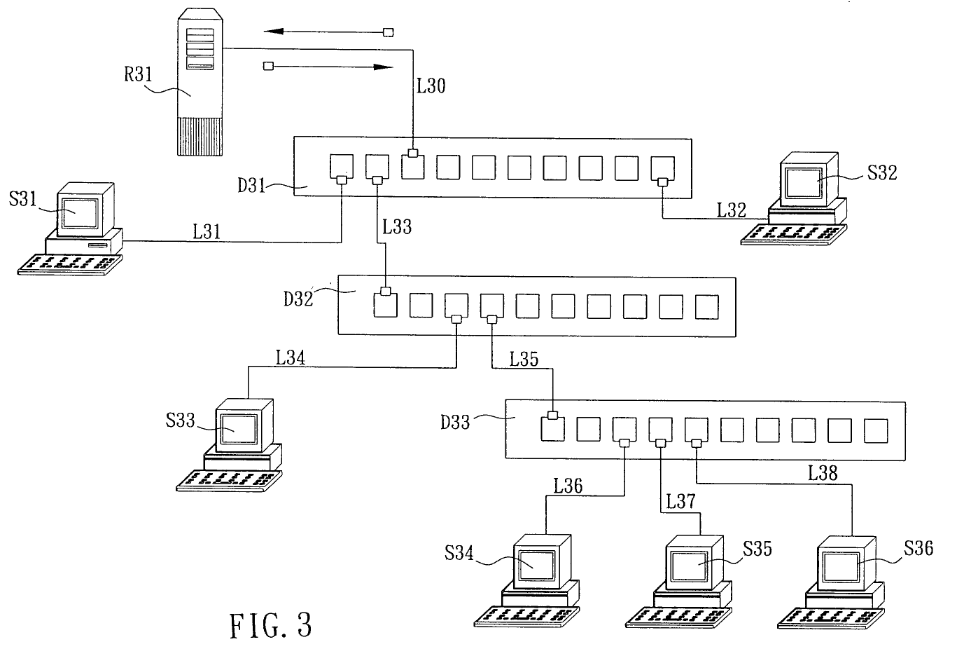

Referring to FIG. 3, it presents schematically the connection of a concentrated authentication in a hierarchical intermedia architecture for managing the intermedia according to a preferred embodiment of the invention. In the hierarchical intermedia of the embodiment, there is provided a RADIUS server R31 served as a server for the concentrated authentication. The RADIUS server R31 is sequentially connected to at least one intermedium in the hierarchical intermedia architecture. In the embodiment (FIG. 3), the RADIUS server R31 is connected to a connection port of a first intermedium D31 via a line L30. Further, the first intermedium D31 is connected to a connection port of a second intermedium D32 via a line L33. And in turn the second intermedium D32 is connected to a connection port of a third intermedium D33 via a line L35. In this manner the hierarchical intermedia architecture according to the invention is formed. In the embodiment, the first intermedium D31 is connected to connection ports of a first end point S31 and a second end point S32 via lines L31 and L32 respectively. The second intermedium D32 is connected to a connection port of a third end point S33 via a line L34. The third intermedium D33 is connected to connection ports of a fourth end point S34, a fifth end point S35, and a sixth end point S36 via lines L36, L37, and L38 respectively.

In the embodiment, a hierarchical back traced protocol packet is devised in the hierarchical intermedia architecture. When one end point finds that it does not pass an authentication the end point can issue the protocol packet for requesting the intermedia to back trace nodes in the hierarchical intermedia architecture sequentially. As a result, each end point can quickly know which node fails the authentication. In this regard, it is required to first define contents of the protocol packet in order to establish the back trace mechanism. As an end, each intermedium can have a back trace capability. The protocol packet may be classified as either a request packet or a response packet with respect to type. The request packet is sent from an intermedium at a lower layer of the hierarchical intermedia architecture to an intermedium at an upper layer. To the contrary, the response packet is sent from the intermedium at the upper layer of the hierarchical intermedia architecture to the intermedium at the lower layer with relevant information being brought back.

As to the hierarchical intermedia architecture by referring to the embodiment of FIG. 3 again, in the hierarchical intermedia architecture it is assumed that in a first layer S31, D32, and S32 pass the authentication (i.e., L31, L33, and L32 are in communication enabled statuses); in a second layer S33 passes the authentication but D33 fails the authentication (i.e., L34 is in a communication enabled status but L35 is in a communication disabled status); and in a third layer S34, S35, and S36 fail the authentication. In receiving or sending the back traced request packet by each intermedium, two schemes are implemented for processing as detailed below.

Scheme I:

When the fourth end point S34 issues a back traced request packet, the third intermedium D33 will receive the back traced request packet and generate a back traced response packet since the third intermedium D33 does not pass the authentication of the fourth end point S34. Next the back traced response packet is sent back to the fourth end point S34. At the same time, the third intermedium D33 issues a back traced request packet for sending to the second intermedium D32 at an upper layer. Likewise, the second intermedium D32 will generate a back traced response packet since the second intermedium D32 does not pass the authentication of the third intermedium D33. Next the back traced response packet is sent back to the third intermedium D33 at a lower layer. At the same time, the second intermedium D32 issues a back traced request packet for sending to the first intermedium D31 at the upper layer. At this time, basic information of the passed authentication is sent back to the fourth end point S34 via the second and the third intermedia D32 and D33 respectively since the first intermedium D31 has passed the authentication of the second intermedium D32.

In the embodiment, a format of each of the back traced request packet and response packet can be one of two formats as below.

Format I:

| SA | DA | Code | State | Depth | Length | Description |
|---|---|---|---|---|---|---|
| Char[6] | Char[6] | Integer | Integer | Integer | Integer | Char[ ] |

Format II:

| SA | DA | Code | State | Depth | Type |
|---|---|---|---|---|---|
| Char[6] | Char[6] | Integer | Integer | Integer | Integer |

Following is a detailed description of fields shown above:

field SA: It represents a source address of the sent packet;

field DA: It represents a destination address of the packet to be sent;

field Code: It represents a value of the request packet or the response packet wherein value of 0 means a request packet and value of 1 means a response packet;

field Depth: It represents a depth of the source address of the sent request packet wherein the depth=1 if the request packet is sent from the third intermedium D33; the depth=2 if the request packet is sent from the second intermedium D32; and the depth=3 if the request packet is sent from the first intermedium D31;

field State: It represents a value of authentication success of fail wherein value of 0 means fail and value of 1 means success;

field Length: It represents a length of the description;

field Description: It represents a basic description of the authentication problems; and

field Type: It represents a basic type of the authentication problems which are predefined but permitting a possible expansion at future times wherein type 0 means an authentication success, type 1 means a failed RADIUS server authentication, type 2 means no response from the RADIUS server, type 3 means a failed intermedian authentication, and type 4 means no response from the intermedia. Further, Char[ ] and Integer represent attributes of data in the field to be string and integer respectively.

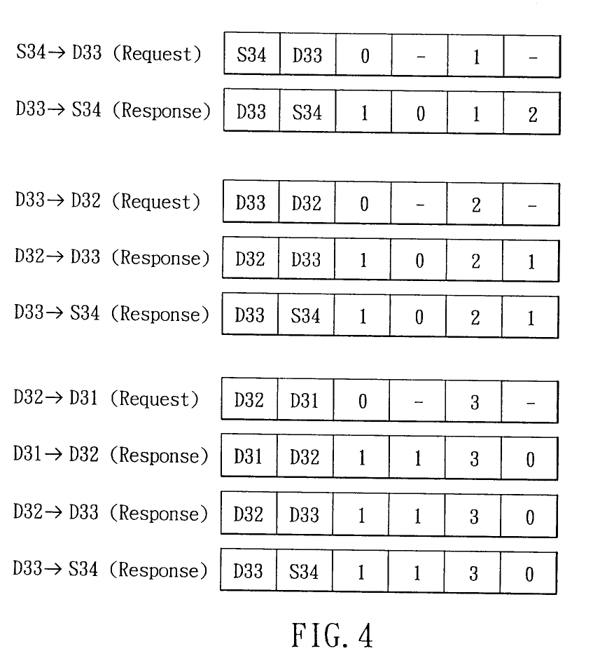

As stated above, in the embodiment in response to a request packet from the fourth end point S34 regarding a connection to other end points and an immediate receiving of information about authentication fail, the fourth end point S34 will send a back traced request packet to back trace a result of the authentication. Next, response packets in response to the back traced request packet are sent back from the intermedia. The response packets are then analyzed by the fourth end point S34. The analyzed response packets contain information as shown in the following table (i.e., format 11 with detailed contents of the packet shown in FIG. 4)

| SA | DA | State | Depth | Type |
|---|---|---|---|---|
| D33 | S34 | authentication fail | 1 | No response from |
| | | | | RADIUS server |
| D33 | S34 | authentication fail | 2 | Password error |
| D33 | S34 | authentication ass | 3 | — |

Scheme II:

When the fourth end point S34 issues a back traced request packet, the third intermedium D33 will receive the back traced request packet and generate a back traced response packet since the third intermedium D33 does not pass the authentication of the fourth end point S34. Next the back traced response packet is sent back to the fourth end point S34. At the same time, the third intermedium D33 issues a back traced request packet for sending to the second intermedium D32 at the upper layer. Likewise, the second intermedium D32 will generate a back traced response packet since the second intermedium D32 does not pass the authentication of the third intermedium D33. Next the back traced response packet is sent back directly to the initial fourth end point S34. At the same time, the second intermedium D32 issues a back traced request packet for sending to the first intermedium D31 at the upper layer. At this time, basic information of the passed authentication is sent back directly to the fourth end point S34 respectively since the first intermedium D31 has passed the authentication of the second intermedium D32.

In the embodiment, a format of each of the back traced request packet and response packet can be one of two formats as below.

Format III:

Format III:

| SA | DA | Code | SSA | SDA | State | Depth | Length | Description |
|---|---|---|---|---|---|---|---|---|
| Char[6] | Char[6] | Integer | Char[6] | Char[6] | Integer | Integer | Integer | Char[] |

Format IV:

| SA | DA | Code | SSA | SDA | State | Depth | Type |
|---|---|---|---|---|---|---|---|
| Char[6] | Char[6] | Integer | Char[6] | Char[6] | Integer | Integer | Integer |

Following is a detailed description of fields shown above:

field SA: It represents a source address of the sent packet;

field DA: It represents a destination address of the packet to be sent;

field Code: It represents a value of the request packet or the response packet wherein value of 0 means a request packet and value of 1 means a response packet;

field SSA: It represents the back traced start source address if it is a format of the request packet; or it represents the back traced segment source address of authentication if it is a format of the response packet;

field SDA: It represents the back traced scale destination address if it is a format of the request packet; or it represents the back traced segment destination address of authentication if it is a format of the response packet;

field Depth: It represents a depth of the source address of the sent request packet wherein the depth=1 if the request packet is sent from the third intermedium D33; the depth =2 if the request packet is sent from the second intermedium D32; and the depth=3 if the request packet is sent from the first intermedium D31;

field State: It represents a value of authentication success of fail wherein value of 0 means fail and value of 1 means success;

field Length: It represents a length of the description;

field Description: It represents a basic description of the authentication problems; and

field Type: It represents a basic type of the authentication problems which are predefined but permitting a possible expansion at future times wherein type 0 means an authentication success, type 1 means a failed RADIUS server authentication, type 2 means no response from the RADIUS server, type 3 means a failed intermedian authentication, and type 4 means no response from the intermedia. Further, Char[ ] and Integer represent attributes of data in the field to be string and integer respectively.

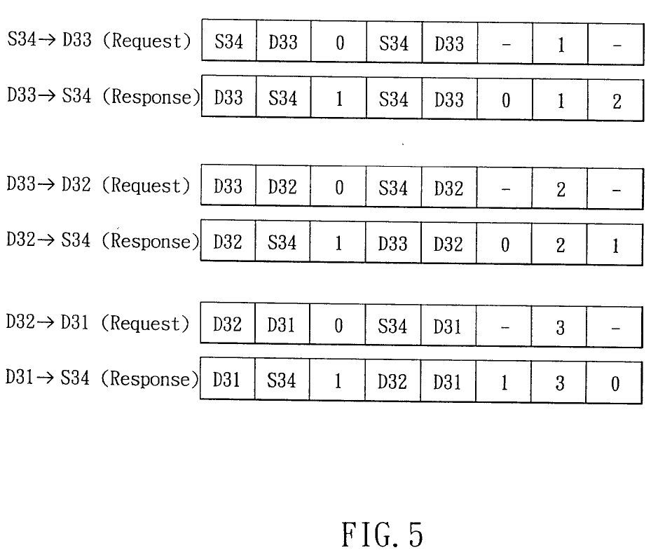

As stated above, in the embodiment in response to a request packet from the fourth end point S34 regarding a connection to other end points and an immediate receiving of information about authentication fail, the fourth end point S34 will send a back traced request packet to back trace a result of the authentication. Next, response packets in response to the back traced request packet are sent back from the intermedia. The response packets are then analyzed by the fourth end point S34. The analyzed response packets contain information as shown in the following table (i.e., format IV with detailed contents of the packet shown in FIG. 5)

| SA | DA | SSA | SDA | State | Depth | Type |
|---|---|---|---|---|---|---|
| D33 | S34 | S34 | D33 | Authentication | 1 | No response |
| | | | | fail | | from RADIUS |
| | | | | | | server |
| D32 | S34 | D33 | D32 | Authentication | 2 | Password |
| | | | | fail | | error |
| D31 | S34 | D32 | D31 | Authentication | 3 | — |
| | | | | pass | | |

Hence, for a hierarchical intermedia architecture providing a 802.1x authentication mechanism the back traced request packets and response packets of the invention can enable a user or manager to clearly and quickly back trace errors occurred on the intermedia. The errors are then corrected immediately so as to greatly reduce time spent on error detection and debugging in the authentication process and significantly increase a convenience of network concentrated authentication, management and maintenance.

In the invention, as to contents of the back traced request packets and response packets only error messages about authentication problems are included rather than additional information about contents of the intermedia. Thus, a hacker is only capable of understanding failed devices and associated error messages by knowing contents of the packets by utilizing the back trace mechanism for invading the network. However, the hacker is not capable of obtaining more useful information from the back trace mechanism. As a result, an invasion into the intermedia and a potential damage thereto are prevented.

While the invention has been described by means of specific embodiments, numerous modifications and variations could be made thereto by those skilled in the art without departing from the scope and spirit of the invention set forth in the claims.

What is claimed is:

1. A method for back tracing an authentication status being implemented in a hierarchical intermedia architecture including a RADIUS server served as a server of concentrated authentication being sequentially connected to at least one intermedium by means of a hierarchical connection, each intermedium being connected to at least one end point respectively, the hierarchical intermedia architecture utilizing a hierarchical back trace protocol packet so that when each one of a plurality of end points finds that it does not pass an authentication the end point can issue the protocol packet for requesting the intermedia to back trace nodes in the hierarchical intermedia architecture sequentially and commanding the intermedia to send back information about authentication pass and authentication fail of all intermedia, thereby enabling the end point to quickly identify the authentication status and error reasons of the intermedia by analyzing the information.

2. The method of claim 1, wherein the protocol packet comprises a request packet issued from each end point, the request packet being sent from the intermedium at a lower layer distal from the RADIUS server to the intermedium at an upper layer adjacent the RADIUS serve via the hierarchical intermedia architecture.

3. The method of claim 1, wherein the protocol packet further comprises a response packet containing information about the authentication pass or fail of all intermedia issued from the intermedium at the upper layer adjacent the RADIUS server to the intermedium of the lower layer and each end point distal from the RADIUS server via the hierarchical intermedia architecture.

4. The method of claim 1, wherein a format of the protocol packet comprises:
a first field representing a source address of the sent packet,
a second field representing a destination address of the packet to be sent,
a third field representing a value of the request packet or the response packet, and
a fourth field representing a type of authentication problems which are predefined.

5. The method of claim 1, wherein the format of the protocol packet comprises:
a first field representing a source address of the sent packet,
a second field representing a destination address of the packet to be sent,
a third field representing a value of the request packet or the response packet,
a fourth field representing a length of a description, and
a fifth field representing the description of authentication problems.

6. The method of claim 4, wherein the format of the protocol packet further comprises a depth field representing a depth of the source address of the sent request packet.

7. The method of claim 5, wherein the format of the protocol packet further comprises a depth field representing a depth of the source address of the sent request packet.

8. The method of claim 4, wherein the format of the protocol packet further comprises a time field representing an arrival time of the packet.

9. The method of claim 5, wherein the format of the protocol packet further comprises a time field representing an arrival time of the packet.
